(19) United States
(12) Patent Application Publication
(10) Pub. No.: US 2026/0116072 A1
(43) Pub. Date: Apr. 30, 2026

(54) INKJET PRINTING APPARATUS

(71) Applicant: Genix Corporation, Seongnam-si (KR)

(72) Inventors: Steve PARK, Seongnam-si (KR); Soon Ho HONG, Namyangju-si (KR); Seoung Il KONG, Gwacheon-si (KR)

(21) Appl. No.: 19/348,591

(22) Filed: Oct. 2, 2025

(30) Foreign Application Priority Data
Oct. 24, 2024 (KR) 10-2024-0146975

(51) Int. Cl. B41J 2/165; B41J 2/045

(52) U.S. Cl. CPC B41J 2/16505; B41J 2/0457; B41J 2/04571; B41J 2/04581; B41J 2/16579

(57) ABSTRACT

An ink printing apparatus includes an inkjet print head arranged to be movable in a designated direction and including a first print head nozzle configured to jet ink droplets and a second print head nozzle configured to jet a cleaning liquid. The ink printing apparatus may also include a capping unit detachably coupled to the inkjet print head and protecting the first print head nozzle and the second nozzle when coupled to the inkjet print head. The ink printing apparatus may further include a wiper removing solidified ink droplets around the first print head nozzle. The ink printing apparatus may further include a processor operatively connected to the inkjet print head and the capping unit, and configured to jet the cleaning liquid to the wiper through the inkjet print head.

### CROSS-REFERENCE TO RELATED APPLICATION

This application is based on and claims priority under 35 U.S.C. § 119 to Korean Patent Application No. 10-2024-0146975, filed on Oct. 24, 2024, in the Korean Intellectual Property Office, the disclosure of which is incorporated by reference herein in its entirety.

### BACKGROUND

### Technical Field

The disclosure relates to an inkjet printing apparatus capable of cleaning a wiper by jetting a cleaning liquid to the wiper through an inkjet print head.

### Description of Related Technology

An inkjet printing apparatus is an apparatus by which desired images may be printed onto print areas of a print media by jetting printing ink to the print media through an inkjet print head. More particularly, the inkjet printing apparatus may print an image having a certain color on a surface of the print media by jetting ink droplets having fine sizes to a desired position on the print media through a print head nozzle of the inkjet print head.

### SUMMARY

One aspect is an inkjet printing apparatus which jets a cleaning liquid to a wiper through an inkjet print head capable of jetting the cleaning liquid as well as ink droplets, to thereby clean the wiper without an increase in the size of the inkjet printing apparatus.

The technical aspects of the present disclosure are not limited to those described herein, and other aspects may be clearly understood by one of ordinary skill in the art from the embodiments to be described hereinafter.

Additional aspects will be set forth in part in the description which follows and, in part, will be apparent from the description, or may be learned by practice of the presented embodiments of the disclosure.

One aspect is an ink printing apparatus that includes an inkjet print head arranged to be movable in a designated direction and including a first print head nozzle configured to jet ink droplets and a second print head nozzle configured to jet a cleaning liquid, a capping unit detachably coupled to the inkjet print head and configured to protect the first print head nozzle and the second nozzle when coupled to the inkjet print head, a wiper configured to remove solidified ink droplets around the first print head nozzle, and a processor operatively connected to the inkjet print head and the capping unit, wherein the processor is configured to jet the cleaning liquid to the wiper through the inkjet print head.

For example, the processor may be further configured to, when the inkjet print head and the capping unit are coupled to each other, move the capping unit such that the capping unit is detached from the inkjet print head, when the capping unit is detached from the inkjet print head, move the inkjet print head such that the second print head nozzle is arranged at a position corresponding to a position of the wiper, and jet the cleaning liquid to the wiper through the second print head nozzle.

In addition, the processor may be further configured to, after jetting the cleaning liquid to the wiper through the second print head nozzle, move the capping unit in a direction toward the inkjet print head and such that capping unit and the inkjet print head are coupled again to each other.

For example, the processor may be further configured to adjust an amount of cleaning liquid jetted through the second print head nozzle.

In an embodiment, the inkjet print head may further include a first piezoelectric element configured to discharge the ink droplets outside the inkjet print head through the first print head nozzle, a second piezoelectric element configured to discharge the cleaning liquid outside the inkjet print head through the second print head nozzle, and a sensor configured to detect a temperature of the cleaning liquid.

Here, the processor may be further configured to adjust an electrical signals applied to the second piezoelectric element based on the temperature of the cleaning liquid detected through the sensor, such that a constant amount of the cleaning liquid is capable of being jetted to the wiper.

For example, the inkjet printing apparatus may further include a memory, in which pieces of data regarding correlations between temperatures of the cleaning liquid and viscosities of the cleaning liquid are stored, and the processor may be further configured to adjust the electrical signal applied to the second piezoelectric element, based on the pieces of data regarding the correlations between the temperatures of the cleaning liquid and the viscosities of the cleaning liquid, the pieces of data being stored in the memory.

In an embodiment, the inkjet printing apparatus may further include a fixing wall arranged adjacent to the wiper and a roller configured to push the wiper in a direction toward the fixing wall.

In this case, the processor may be further configured to have the wiper adhere to the fixing wall through the roller and jet the cleaning liquid to the wiper through the inkjet print head.

In addition, the processor may be further configured to additionally jet the cleaning liquid to the fixing wall and the roller by moving the inkjet print head.

In another example, the inkjet printing apparatus may further include a scrapper arranged to rotate with respect to the fixing wall and configured to remove the cleaning liquid remaining on the fixing wall.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a perspective view illustrating an inkjet printing apparatus according to an embodiment.

FIG. 2 is a cross-sectional view of the inkjet printing apparatus illustrated in FIG. 1.

FIG. 3 is a block diagram illustrating components of an inkjet printing apparatus according to an embodiment.

FIG. 4 is a flowchart for describing operations to clean a wiper of an inkjet printing apparatus according to an embodiment.

FIG. 5 is a diagram for describing a process of detaching a capping unit of an inkjet printing apparatus from an inkjet print head according to an embodiment.

FIG. 6 is a diagram for describing a process of jetting a cleaning liquid to a wiper after moving the inkjet print head of the inkjet printing apparatus in FIG. 5.

FIG. 7 is a cross-sectional view of an inkjet printing apparatus, according to another embodiment.

FIG. 8 is a graph for describing a change in electrical signals applied to a piezoelectric element in the inkjet printing apparatus illustrated in FIG. 7.

FIG. 9 is a cross-sectional view of an inkjet printing apparatus according to another embodiment.

FIG. 10 is a diagram for describing a process of jetting a cleaning liquid to a wiper of the inkjet printing apparatus illustrated in FIG. 9.

### DETAILED DESCRIPTION

In an operation process of the inkjet printing apparatus, some of the ink droplets may be solidified around the print head nozzle, and when the solidified ink droplets block the print head nozzle, printing performance of the inkjet printing apparatus may be degraded. Accordingly, various methods have been studied to prevent degradation of the printing performance of the inkjet printing apparatus due to the solidified ink droplets.

An inkjet printing apparatus in which a wiper (or ‘a blade’) is used has been suggested as a solution to prevent degradation in printing performance due to solidified ink droplets. Such an inkjet printing apparatus removes solidified ink droplets around a print head nozzle through the wiper, to thereby prevent the degradation in the printing performance due to solidified ink droplets.

However, even in this case, when a certain amount or more of the solidified ink droplets remain on the wiper in a process of use, the solidified ink droplets around the print head nozzle may be not smoothly removed, and therefore, a solution to enable cleaning of the wiper is additionally required.

In the related art, additional components such as a cleaning roller were added to an inkjet printing apparatus to clean a wiper, however, when the additional components are added, the entire size of the inkjet printing apparatus increases, and furthermore, the wiper is not evenly cleaned and thus solidified ink remains on the wiper.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Regarding terms used in embodiments, general terms currently and wisely used are selected in consideration of functions in the disclosure. However, meanings of the terms may be changed according to intentions of one of ordinary skill in the art, judicial precedence, appearance of a new technology, and the like. In addition, in certain cases, terms may be arbitrarily selected by the applicant in particular cases. In such a case, the meaning of the terms will be described in detail at the corresponding portion in the description of the disclosure. Therefore, the terms used in the disclosure should be defined based on the meanings of the terms and the descriptions throughout the disclosure.

In the disclosure, expression that a portion “includes” components or operations should not be interpreted as including all components or operations, but should be interpreted that the portion may not include some of the components or operations or further include additional components and operations. The terms “-er”, “-or”, and “module” described in the disclosure indicate units for processing at least one function and operation, and may be implemented by hardware components or software components and combinations thereof.

As used herein, an expression such as “at least only one” precedes arranged elements, it modifies all elements rather than each arranged elements. For example, the expression “at least any one of a, b, and c” should be construed to include a, b, c, or a and b, a and c, b and c, or a, b, and c.

In the disclosure, “inkjet printing apparatus” may indicate an apparatus by which an image may be printed onto a print media (or ‘print medium’) by discharging fine-sized ink droplets on a desired position of the print media.

Hereinafter, embodiments will be described in detail with reference to the accompanying drawings such that the embodiments may be easily practiced by one of ordinary skill in the art. The embodiments may be implemented in various forms and are not limited to those described herein.

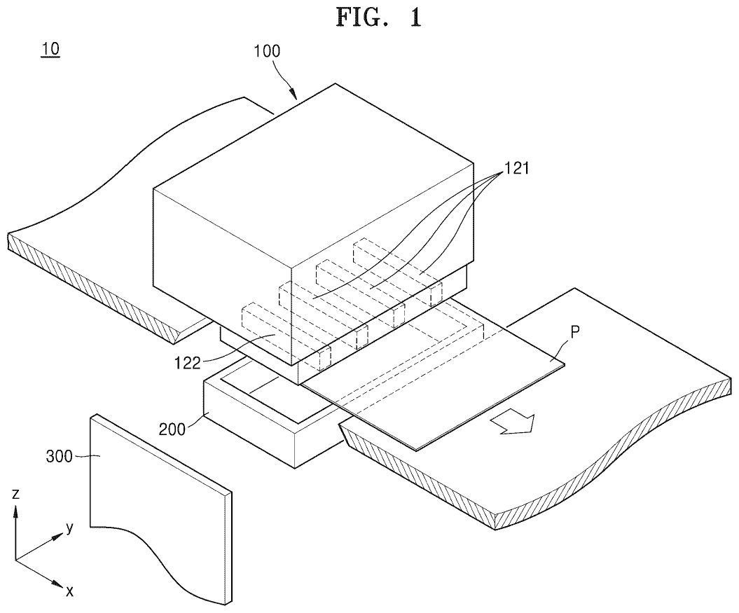

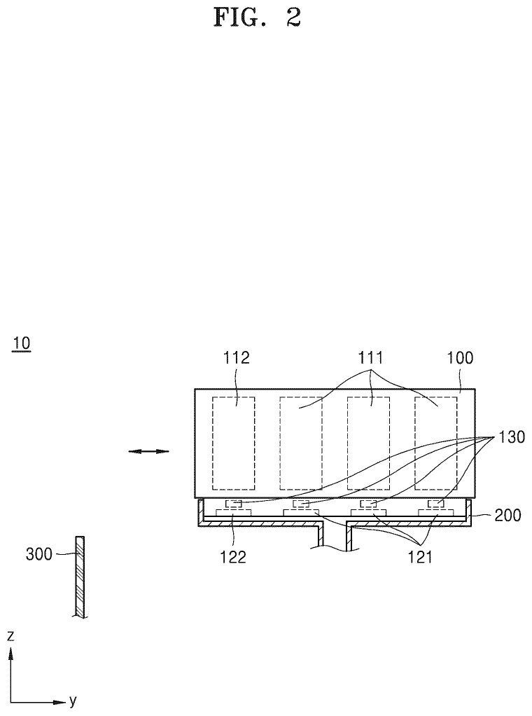

FIG. 1 is a perspective view illustrating an inkjet printing apparatus 10 according to an embodiment, and FIG. 2 is a cross-sectional view of the inkjet printing apparatus 10 illustrated in FIG. 1. Here, FIG. 2 illustrates a case in which an inkjet print head 100 and a capping unit 200 are coupled to each other.

Referring to FIGS. 1 and 2, the inkjet printing apparatus 10 according to an embodiment may include the inkjet print head 100, the capping unit 200, and a wiper 300, and may be configured to print an image onto a print media P by discharging ink droplets toward the print media P.

The inkjet print head 100 may be configured to print the image onto the print media P by discharging ink droplets of fine sizes (e.g.: tens of pico-liters) at desired positions of the print media P while moving along a designated path. In this case, the print media P may include, but is not limited to, at least one of paper, a film, or a fiber.

In an embodiment, the print media P may move in a first direction (e.g.: x direction or −x direction in FIG. 1), and the inkjet print head 100 may discharge, at a fixed position, ink droplets to the print media P on the move, but a method of discharging the ink droplets by the inkjet print head 100 is not limited thereto.

In another embodiment, the print media P may move in the first direction and arrive at the inkjet print head 100, and the inkjet print head 100 may discharge the ink droplets to the print media P that has arrived at the inkjet print head 100, while moving in a second direction (e.g.: y direction or −y direction in FIG. 1) crossing the first direction. In another embodiment, the inkjet print head 100, while moving in the second direction, may discharge the ink droplets onto the print media P moving in the first direction.

According to an embodiment, the inkjet print head 100 may include a first cartridge 111, a second cartridge 112, a first print head nozzle 121, a second print head nozzle 122, and a piezoelectric element 130.

The ink droplets may be stored in the first cartridge 111, and unlike in the first cartridge 111, a cleaning liquid may be stored in the second cartridge 112. For example, at least one of key or black ink, cyan ink, magenta ink, and/or yellow ink may be stored in the first cartridge 111, but the embodiment is not limited thereto. In addition, although the drawing only illustrates an embodiment in which the number of the first cartridges 111 is three, but the number of the first cartridges 111 is not limited thereto.

The inkjet print head 100 of the related art usually only includes a cartridge in which ink droplets are stored. However, the inkjet print head 100 according to an embodiment, which includes the first cartridge 111 storing the ink droplets and the second cartridge 112 storing the cleaning liquid, may store both the ink droplets and the cleaning liquid.

The first print head nozzle 121 may be arranged to be fluidly connected to or to fluidly communicate with an inner portion of the first cartridge 111, and may serve to discharge the ink stored in the first cartridge 111 onto the print media P. For example, the first print head nozzle 121 may be at a bottom of the inkjet print head 100 (e.g., −z direction) and may be fluidly connected to the first cartridge 111 through an ink supply path (not shown), but a position to arrange the first print head nozzle 121 and a connection type between the first print head nozzle 121 and the first cartridge 111 are not limited thereto.

The second print head nozzle 122 may be arranged to be fluidly connected to or to fluidly communicate with an inner portion of the second cartridge 112, and may serve to discharge the cleaning liquid stored in the second cartridge 112 to the wiper 300. For example, the second print head nozzle 122 may be at an area adjacent to the first print head nozzle 121 at the bottom of the inkjet print head 100 and be fluidly connected to the second cartridge 112 through a cleaning liquid supply path (not shown), but a position to arrange the second print head nozzle 122 and a connection type between the second print head nozzle 122 and the second cartridge 112 are not limited thereto.

The piezoelectric element 130 may be configured to provide a driving force for the ink stored in the first cartridge 111 and/or the cleaning liquid stored in the second cartridge 112 to be discharged outside the inkjet print head 100 through the first print head nozzle 121 and/or the second print head nozzle 122. For example, the piezoelectric element 130 may include a first piezoelectric element, which is configured to provide a driving force for the ink droplets to be discharged outside the inkjet print head 100 through the first print head nozzle 121, and a second piezoelectric element configured to provide a driving force for the cleaning liquid to be discharged outside the inkjet print head 100 through the second print head nozzle 122.

The piezoelectric element 130 may be physically transformed in accordance with supply of an electrical signal. For example, the piezoelectric element 130 may be physically transformed while stretching, contracting, or expanding in response to an electrical signal, but is not limited thereto.

Due to physical transformation of the piezoelectric element 130, a pressure may be applied to the ink supply path and/or the cleaning liquid supply path, and as a result thereof, the ink and/or the cleaning liquid may be discharged outside the inkjet print head 100 through the first print head nozzle 121 and/or the second print head nozzle 122. For example, when the pressure is applied to the ink supply path due to the transformation of the piezoelectric element 130, the ink in the ink supply path may be discharged outside the inkjet print head 100 through the first print head nozzle 121. In another example, when the pressure is applied to the cleaning supply path due to the transformation of the piezoelectric element 130, the cleaning liquid in the cleaning liquid supply path may be discharged outside the inkjet print head 100 through the second print head nozzle 122.

The capping unit 200 may be detachably coupled to the inkjet print head 100, and may serve to protect the inkjet print head 100 when coupled to the inkjet print head 100. For example, the capping unit 200 may be detachably coupled to an area of the inkjet print head 100, in which the first print head nozzle 121 and/or the second print head nozzle 122 is/are arranged, and may protect the first print head nozzle 121 and/or the second print head nozzle 122 from external impact or introduction of foreign materials.

According to an embodiment, the capping unit 200 may be coupled to the inkjet print head 100 or detached from the inkjet print head 100 while moving in a z direction or the −z direction through a driving unit (not shown). For example, the driving unit may include a cam being in contact with at least an area of the capping unit 200, and the capping unit 200 may move in the z direction or the −z direction in correspondence to rotation of the cam, but a type of the driving unit is not limited thereto.

For example, as the capping unit 200 moves in the −z direction away from the inkjet print head 100, the capping unit 200 may be detached from the inkjet print head 100. On the other hand, as the capping unit 200 moves in the z direction while being detached from the inkjet print head 100, the capping unit 200 may be coupled to the inkjet print head 100.

In the inkjet printing apparatus 10 according to an embodiment, through the driving unit, the capping unit 200 may be detached from the inkjet print head 100 while the inkjet print head 100 operates or cleans the wiper 300, and the inkjet print head 100 and the capping unit 200 may be coupled to each other while the inkjet print head 100 does not operate, to protect the first print head nozzle 121 and/or the second print head nozzle 122.

The wiper 300 may serve to remove the ink droplets adhered to the inkjet print head 100. For example, the wiper 300 may serve to remove solidified ink droplets around the first print head nozzle 121 configured to discharge the ink droplets.

Some of the ink droplets may be solidified in a process of discharging the ink droplets through the first print head nozzle 121, and the solidified ink droplets may degrade jetting performance of the first print head nozzle 121. For example, when the solidified ink droplets block the first print head nozzle 121, ink jetting performance of the first print head nozzle 121 may be degraded and cause general degradation in printing performance of the inkjet printing apparatus 10.

As the inkjet print head 100 moves, the first print head nozzle 121 and the wiper 300 may be arranged adjacent to each other, and in the aforementioned state, the wiper 300 may remove the solidified ink droplets around the first print head nozzle 121 by scraping or shredding the solidified ink droplets. For example, the solidified ink droplets around the first print head nozzle 121 may be removed as the wiper 300 moves in the −y direction or y direction while the first print head nozzle 121 and the wiper 300 are arranged adjacent to each other, but a method of removing the solidified ink droplets is not limited thereto.

In a process of removing the solidified ink droplets around the first print head nozzle 121 by the wiper 300, at least some of the solidified ink droplets may be deposited on the wiper 300, and when at least a certain amount of the solidified ink droplets is deposited on the wiper 300, cleaning performance of the wiper 300 may be degraded. For example, when the solidified ink droplets are deposited at an end of the wiper 300 adjacent to the first print head nozzle 121, due to the solidified ink droplets, the solidified ink droplets may be not removed from around the first print head nozzle 121 even when the wiper 300 moves.

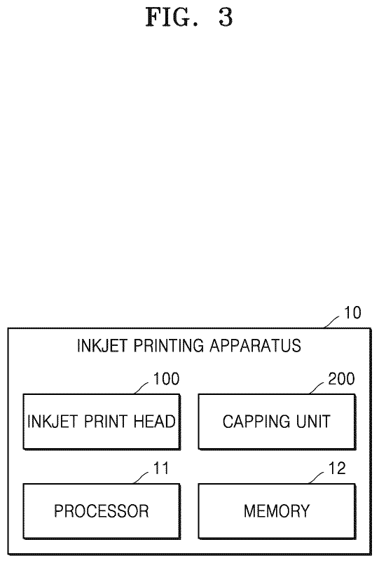

The inkjet printing apparatus 10 according to an embodiment discharges the cleaning liquid toward the wiper 300 to clean the solidified ink droplets deposited on the wiper 300, thereby maintaining the cleaning performance of the wiper 300. For example, the inkjet printing apparatus 10 may move the inkjet printing apparatus 10 in the y direction or −y direction and then discharge the cleaning liquid to the wiper 300 through the second print head nozzle 122. Hereinafter, a process in which the inkjet printing apparatus 10 discharges the cleaning liquid will be described in detail with reference to FIGS. 3 to 6.

FIG. 3 is a block diagram illustrating components of the inkjet printing apparatus 10 according to an embodiment.

Referring to FIG. 3, the inkjet printing apparatus 10 according to an embodiment may include the inkjet print head 100 (e.g., the inkjet print head 100 in FIGS. 1 and 2), the capping unit 200 (e.g., the capping unit 200 in FIGS. 1 and 2), a processor 11, and a memory 12. Components of the inkjet printing apparatus 10 are not limited to the components illustrated in the drawings, and according to embodiments, any one component (e.g., the wiper 300 in FIG. 1 or 2) may be added, or any one component (e.g., the memory 12) may be omitted. The components of the inkjet printing apparatus 10 may be identical or similar to at least one of the components of the inkjet printing apparatus 10 in FIG. 1 and/or FIG. 2, and hereinafter, same descriptions will not be repeatedly given.

The processor 11 may be configured to control general operations of the inkjet printing apparatus 10. For example, the processor 11 may be electrically or operatively connected to the driving unit for moving the inkjet print head 100 and/or the capping unit 200, and may be configured to control operation of the inkjet print head 100 or movement of the capping unit 200. In the disclosure, the expression “operatively connected” may indicate a state where components are connected to each other to exchange signals through wireless communication or exchange optical signals and/or magnetic signals, and the expression may be used as the same meaning hereinafter.

In an embodiment, the processor 11 may move a position of the inkjet print head 100, or may discharge the ink droplets and/or the cleaning liquid outside the inkjet print head 100 through the first print head nozzle 121 and/or the second print head nozzle 122. For example, the processor 11 may move the inkjet print head 100 such that the first print head nozzle 121 is arranged at a position corresponding to a position of a print media (e.g., the print media P in FIG. 1 or FIG. 2) and then discharge or jet the ink droplets through the first print head nozzle 121 to a designated position on the print media. In addition, the processor 11 may move the inkjet print head 100 such that the second print head nozzle 122 is arranged at a position corresponding to a position of the wiper 300, and then discharge or jet the cleaning liquid to the wiper 300 through the second print head nozzle 122.

According to an embodiment, the processor 11 may be configured to control the operation of the inkjet print head 100 based on data stored in the memory 12. For example, pieces of data regarding correlations between temperatures of the cleaning liquid and viscosities of the cleaning liquid may be stored in the memory 12. Even when a same electrical signal is applied to a piezoelectric element (e.g., the piezoelectric element 130 in FIG. 2), an amount of the cleaning liquid jetted through the second print head nozzle 122 may vary according to the viscosity of the cleaning liquid. Accordingly, the processor 11 may maintain a constant amount of the cleaning liquid jetted through the second print head nozzle 122 by adjusting the electrical signal applied to the piezoelectric element based on the pieces of data stored in the memory 12, i.e., the pieces of data regarding the correlations between the temperatures of the cleaning liquid and the viscosities of the cleaning liquid. Detailed descriptions regarding operation of the processor 11 to adjust the electrical signal applied to the piezoelectric element according to the viscosity of the cleaning liquid will be given later.

In another example, the processor 11 may move the capping unit 200 through the driving unit such that the capping unit 200 is detached from the inkjet print head 100 or the capping unit 200 is coupled to the inkjet print head 100. For example, the processor 11 may have the capping unit 200 detached from the inkjet print head 100 before jetting the cleaning liquid to the wiper 300, but control operation of the processor 11 is not limited thereto.

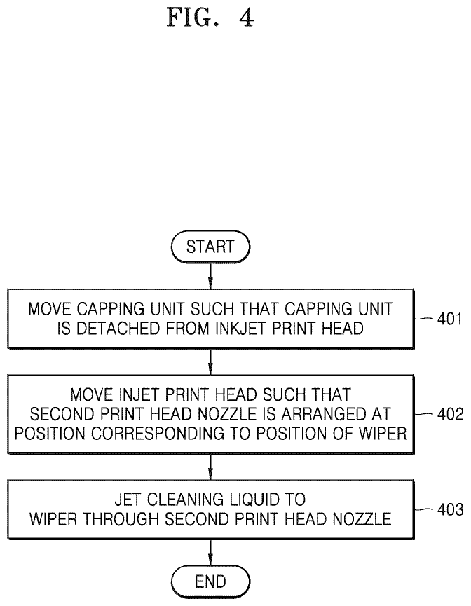

Hereinafter, a process in which the processor 11 cleans the wiper 300 through the inkjet print head 100 and the driving unit will be described in detail with reference to FIGS. 4 to 6.

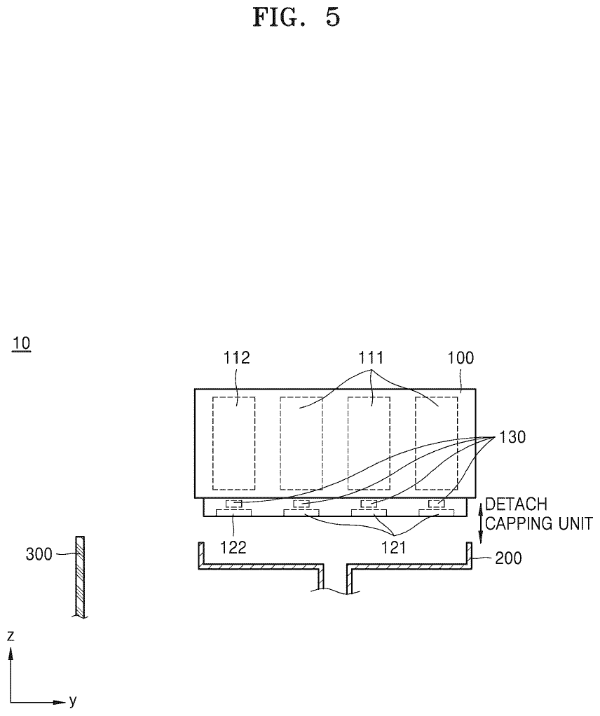

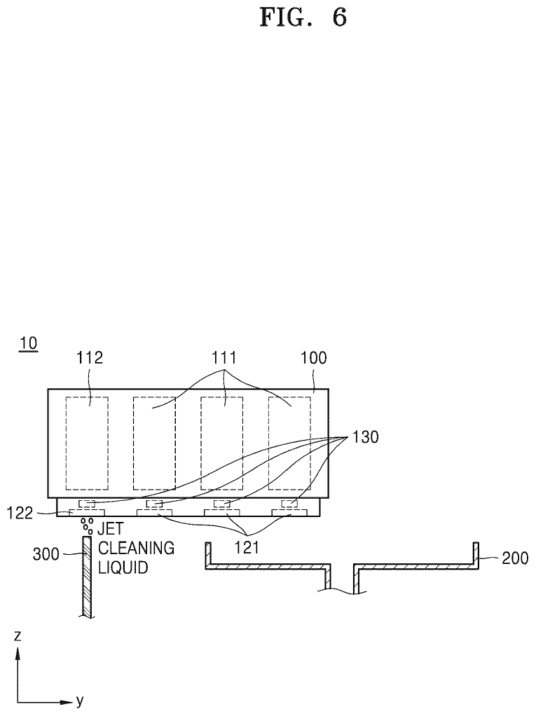

FIG. 4 is a flowchart for describing operations to clean the wiper 300 of the inkjet printing apparatus 10 according to an embodiment. In addition, FIG. 5 is a diagram for describing a process of detaching the capping unit 200 of the inkjet printing apparatus 10 from the inkjet print head 100 according to an embodiment, and FIG. 6 is a diagram for describing a process of jetting the cleaning liquid to the wiper 300 after moving the inkjet print head 100 of the inkjet printing apparatus 10 in FIG. 5. Hereinafter, descriptions about the operations in FIG. 4 to clean the wiper 300 of the inkjet printing apparatus 10 will be given with reference to components illustrated in FIGS. 5 and 6.

Referring to FIG. 4, in operation 401, the inkjet printing apparatus 10 according to an embodiment may move the capping unit 200 in the state where the inkjet print head 100 and the capping unit 200 are coupled to each other, to thereby have the capping unit 200 detached from the inkjet print head 100.

For example, a processor (e.g., the processor 11 in FIG. 3) of the inkjet printing apparatus 10 may move the capping unit 200 in the −z direction away from the inkjet print head 100 through the driving unit, as illustrated in FIG. 5, and as a result thereof, the capping unit 200 may be detached from the inkjet print head 100.

In operation 402, the inkjet printing apparatus 10 according to an embodiment, after having the capping unit 200 detached from the inkjet print head 100 through operation 401, may move the inkjet print head 100 such that the second print head nozzle 122 is arranged at the position corresponding to the position of the wiper 300. For example, the processor of the inkjet printing apparatus 10 may move the inkjet print head 100 and have the second print head nozzle 122 located on top of the wiper 300, as illustrated in FIG. 6.

In the disclosure, the expression “the second print head nozzle 122 is arranged at the position corresponding to the position of the wiper 300” may indicate that the second print head nozzle 122 is on the top of the wiper 300 and thus the second print head nozzle 122 and the wiper 300 are arranged to overlap each other when seen from the z direction, and the expression may be used as the same meaning hereinafter.

In operation 403, the inkjet printing apparatus 10 according to an embodiment, after moving the inkjet print head 100 such that the second print head nozzle 122 is arranged at the position corresponding to the position of the wiper 300 through operation 402, may jet the cleaning liquid to the wiper 300 through the second print head nozzle 122. For example, the processor of the inkjet printing apparatus 10 may apply the electrical signal to the piezoelectric element 130 to cause the cleaning liquid to be jetted from the second print head nozzle 122. As a result thereof, in a process of cleaning the first print head nozzle 121, the solidified ink droplets deposited on the wiper 300 may be cleaned by the cleaning liquid jetted from the second print head nozzle 122.

The inkjet printing apparatus 10 according to an embodiment may jet the cleaning liquid to the wiper 300 through operation 403, and then may move the capping unit 200 in the z direction through the driving unit to have the inkjet print head 100 and the capping unit 200 coupled again to each other, thereby protecting the inkjet print head 100 from external impact or introduction of foreign materials.

According to an embodiment, by repeatedly performing the aforementioned operations 401 to 403 according to a designated cycle, the inkjet printing apparatus 10 may maintain the cleaning performance of the wiper 300 despite repeated use of the inkjet printing apparatus 10.

In inkjet printing apparatuses in the related art, separate cleaning units were generally provided to clean the wiper 300, and due to addition of the separate cleaning units, an increase in the entire size of the inkjet printing apparatus was inevitable.

On the other hand, the inkjet printing apparatus 10 according to an embodiment may clean the wiper 300 through the inkjet print head 100 that already exists, thereby cleaning the wiper 300 without additional cleaning units, and as a result thereof, may maintain the cleaning performance of the wiper 300 while promoting miniaturization of the inkjet printing apparatus 10.

In addition, a large amount of cleaning liquid was wasted while cleaning the wiper 300 in the inkjet printing apparatuses of the related art. However, the inkjet printing apparatus 10 according to an embodiment cleans the wiper 300 in a method of jetting the cleaning liquid to a desired position on the wiper 300 through the second print head nozzle 122, and by doing so, may efficiently remove the solidified ink droplets deposited on the wiper 300 even by using a relatively small amount of the cleaning liquid.

According to another embodiment, the inkjet printing apparatus 10 may perform operation 401 to operation 403 described above, based on the amount of the solidified ink droplets deposited on the wiper 300. For example, the inkjet printing apparatus 10 may further include an observation device (e.g., a camera) configured to obtain image data regarding the wiper 300, and the processor may be configured estimate the amount of the solidified ink droplets deposited on the wiper 300, based on the image data obtained through the observation device.

When the estimated amount of the solidified ink droplets is equal to or greater than a pre-designated amount, the processor may determine that the cleaning performance of the wiper 300 may be degraded and clean the wiper 300 by performing operation 401 to operation 403 described above. That is, the inkjet printing apparatus 10 according to another embodiment may maintain the cleaning performance of the wiper 300 while minimizing power consumption by performing operation 401 to operation 403 only when the amount of the solidified droplets deposited on the wiper 300 is equal to or greater than the designated amount.

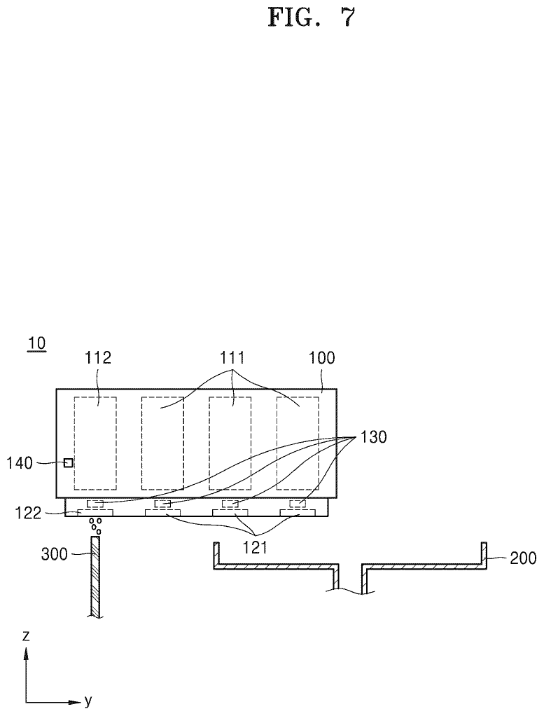

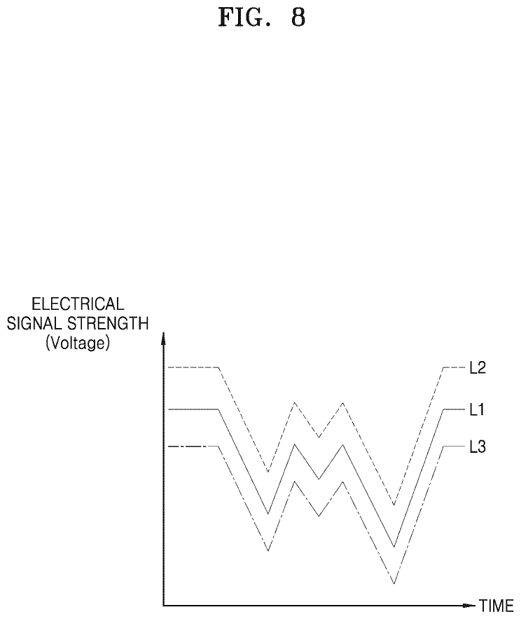

FIG. 7 is a cross-sectional view of the inkjet printing apparatus 10 according to another embodiment, and FIG. 8 is a graph for describing a change in electrical signals applied to the piezoelectric element 130 in the inkjet printing apparatus 10 in FIG. 7.

Referring to FIGS. 7 and 8, the inkjet printing apparatus 10 according to the other element may include the inkjet print head 100, the capping unit 200, and the wiper 300, wherein the inkjet print head 100 includes the first cartridge 111, the second cartridge 112, the first print head nozzle 121, the second print head nozzle 122, the piezoelectric element 130, and a sensor 140. The inkjet printing apparatus 10 according to the other embodiment may be an apparatus in which the sensor 140 is added to the inkjet printing apparatus 10 in FIG. 1 or FIG. 2, and same description will not be repeatedly given hereinafter.

The sensor 140 may be arranged adjacent to the second cartridge 112 and obtain the data regarding the cleaning liquid stored in the second cartridge 112. For example, the sensor 140 may include a temperature sensor, and may obtain data regarding the temperature of the cleaning liquid stored in the second cartridge 112.

A processor (e.g., the processor 11 in FIG. 3) may be configured to adjust the electrical signal applied to the piezoelectric element 130 such that a constant amount of the cleaning liquid may be jetted onto the wiper 300, based on the data regarding of the temperature of the cleaning liquid, obtained through the sensor 140.

As the temperature of the cleaning liquid changes, the viscosity of the cleaning liquid may change. For example, the lower the temperature of the cleaning liquid is, the higher the viscosity of the cleaning liquid may be. Accordingly, even when a same electrical signal is applied to the second piezoelectric element configured to provide a driving force to the second print head nozzle 122, an amount of the cleaning liquid jetted through the second print head nozzle 122 may vary according to the temperature of the cleaning liquid.

For example, when a first electrical signal L1 is applied to the second piezoelectric element and the temperature of the cleaning liquid is a first temperature, a first amount of the cleaning liquid may be jetted through the second print head nozzle 122. On the other hand, when the first electrical signal L1 is applied to the second piezoelectric element and the temperature of the cleaning liquid is a second temperature lower than the first temperature, the viscosity of the cleaning liquid increases, and thus, a second amount of the cleaning liquid may be jetted through the second print head nozzle 122, wherein, the second amount is less than the first amount.

According to an embodiment, the processor may compare the temperature of the cleaning liquid obtained through the sensor 140 with the pieces of data regarding the correlations between the temperatures of the cleaning liquid and the viscosities of the cleaning liquid, stored in a memory (e.g., the memory 12 in FIG. 3) and adjust an electrical signal applied to the second piezoelectric element, such that a constant amount of the cleaning liquid is jetted from the second print head nozzle 122.

For example, as illustrated in FIG. 8, the processor may apply the first electrical signal L1 to the second piezoelectric element when the temperature of the cleaning liquid is the first temperature, and may apply a second electrical signal L2 having a greater strength (or ‘voltage’) than a strength of the first electrical signal L1 to the second piezoelectric element when the temperature of the cleaning liquid is the second temperature lower than the first temperature.

In another example, when the temperature of the cleaning liquid is a third temperature higher than the first temperature, the processor may apply, to the second piezoelectric element, a third electrical signal L3 having a less strength than the strength of the first electrical signal L1.

The inkjet printing apparatus 10 according to another embodiment may maintain the cleaning performance of the wiper 300 by jetting a constant amount of the cleaning liquid onto the wiper 300 regardless of the temperature of the cleaning liquid through the operation of the processor described above.

According to another embodiment, the processor may be further configured to adjust the electrical signal applied to the second piezoelectric element, in consideration of a change in jetting performance of the second print head nozzle 122, as well as the temperature of the cleaning liquid obtained through the sensor 140. For example, when it is determined that the jetting performance of the second print head nozzle 122 is degraded in a process of using the inkjet printing apparatus 10, the processor may apply having an electrical signal having a greater strength than an initial strength to the second piezoelectric element, such that a constant cleaning liquid is jetted despite the degradation in the jetting performance of the second print head nozzle 122, but an embodiment is not limited thereto.

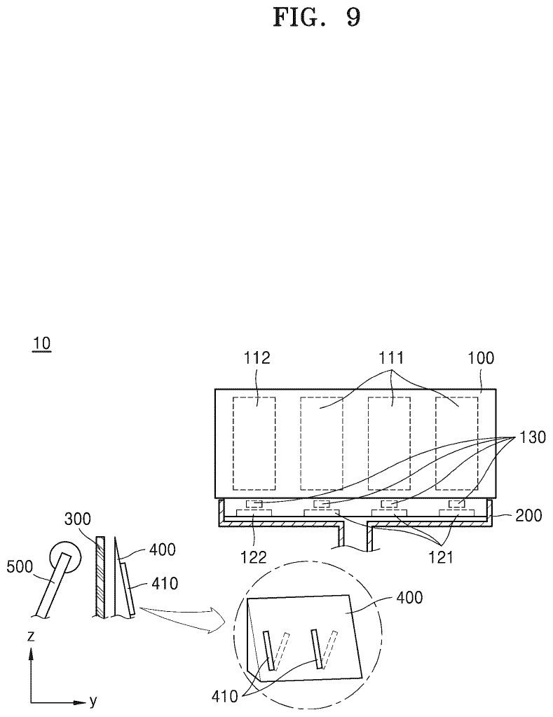

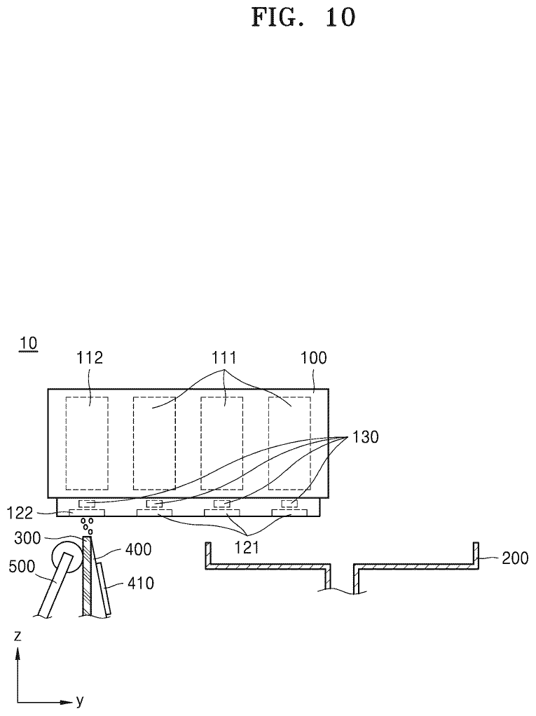

FIG. 9 is a cross-sectional view of the inkjet printing apparatus 10 according to another embodiment, and FIG. 10 is a diagram for describing a process of jetting the cleaning liquid to the wiper 300 of the inkjet printing apparatus 10 in FIG. 9.

Referring to FIGS. 9 and 10, the inkjet printing apparatus 10 according to the other embodiment may include the inkjet print head 100, the capping unit 200, the wiper 300, a fixing wall 400, and a roller 500. The inkjet printing apparatus 10 according to the other embodiment may be an apparatus in which the fixing wall 400 and the roller 500 are added to the inkjet printing apparatus 10 in FIGS. 1 to 2 or the inkjet printing apparatus 10 or FIG. 7, and same descriptions will not be given below.

The inkjet printing apparatus 10 according to the other embodiment, when the cleaning liquid is jetted from the second print head nozzle 122, may fix the position of the wiper 300 by the fixing wall 400 and the roller 500, such that the cleaning liquid is jetted onto a desired position of the wiper 300.

The fixing wall 400 may be arranged adjacent to the wiper 300, and the roller 500 may push the wiper 300 towards the fixing wall 400. For example, as illustrated in FIGS. 9 and 10, the roller 500 may move in the y direction and push the wiper 300 in the y direction, and as a result thereof, the wiper 300 may move by a certain distance in the y direction and adhere to a surface of the fixing wall 400.

According to an embodiment, the processor of the inkjet printing apparatus 10 may have the capping unit 200 detached from the inkjet print head 100 and move the inkjet print head 100 such that the second print head nozzle 122 is arranged at the position corresponding to the position of the wiper 300, as in operation 401 and operation 402 in FIG. 4 described above, and then have the wiper 300 adhere to the fixing wall 400 by controlling operation of the roller 500.

The processor may have the wiper 300 adhere to the fixing wall 400 through the roller 500 and apply the electrical signal to the piezoelectric element 130, thereby jetting the cleaning liquid to the fixed wiper 300 through the second print head nozzle 122 of the inkjet print heat 100. In other words, the processor may control the operation of the roller 500 to have the wiper 300 adhere to the fixing wall 400 before jetting the cleaning liquid onto the wiper 300.

When movement (e.g., shaking) of the wiper 300 occurs in a process of jetting the cleaning liquid, the wiper 300 may be not smoothly cleaned. However, the inkjet printing apparatus 10 according to another embodiment may stably clean the wiper 300 by fixing the wiper 300 and then jetting the cleaning liquid.

According to an embodiment, the fixing wall 400 may have a slope having a certain angle, and the cleaning liquid jetted in a direction toward the wiper 300 may clean the wiper 300 and then flow to a cleaning liquid collector (not shown) along the slope of the fixing wall 400, but an embodiment is not limited thereto. In this case, some of the cleaning liquid may remain on the slope due to the viscosity of the cleaning liquid, and the processor of the inkjet printing apparatus 10 according to another embodiment may cause a scraper 410 arranged on the slope of the fixing wall 400 to rotate, thereby removing the cleaning liquid remaining on the slope of the fixing wall 400.

In addition, the processor may jet the cleaning liquid to the wiper 300 and then move the inkjet print head 100 in the y direction or the −y direction to additionally jet the cleaning liquid to the fixing wall 400 and/or the roller 500 as well as to the wiper 300.

The fixing wall 400 and/or the roller 500 may be stained with the ink droplets washed out in a process of cleaning the wiper 300. The inkjet printing apparatus 10 according to another embodiment may efficiently clean the ink droplets stained on the fixing wall 400 and/or the roller 500 by moving the inkjet print head 100 and additionally jetting the cleaning liquid to the fixing wall 400 and/or the roller 500.

The method according to the embodiments may also be implemented in the form of a recording medium including computer-executable instructions, e.g., a program module executed by a computer. A computer-readable medium may include any available media that may be accessed by a computer and includes all of volatile media, nonvolatile media, removable media, and non-removable media. In addition, the computer-readable medium may include a computer storage medium and a communication medium. The computer storage medium includes both volatile and nonvolatile, and removable and non-removable media implemented in any method or technology for storage of information such as computer readable instructions, data structures, program modules or other data. The communication medium may include computer-readable instructions, data structures, and other data in non-transitory data signals, such as program modules.

It will be understood to one of ordinary skill in the art related to the embodiments that the embodiments may be implemented in a modified form without departing from the scope of the disclosure. Therefore, the embodiments of the disclosure should be considered as illustrative examples only, and should not be construed as limiting the scope of the disclosure. The scope of the disclosure is described in the claims rather than the foregoing description, and any modifications, substitutions and improvements of the embodiments of the disclosure should be construed as being included in the disclosure.

An inkjet printing apparatus according to various embodiments may precisely adjust, through a method of jetting a cleaning liquid onto a wiper through an inkjet print head, a position on which the cleaning liquid is jetted and a jetting amount of the cleaning liquid, and as a result thereof, may efficiently remove solidified ink droplets deposited on the wiper.

Advantageous effects obtained by the embodiments are not limited to the aforementioned embodiments, and other unmentioned effects may be clearly understood to one of ordinary skill in the art based on the present specification and the accompanying drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An inkjet printing apparatus comprising:
an inkjet print head arranged to be movable in a designated direction and comprising a first print head nozzle configured to jet ink droplets and a second print head nozzle configured to jet a cleaning liquid;
a capping unit detachably coupled to the inkjet print head and configured to protect the first print head nozzle and the second nozzle when coupled to the inkjet print head;
a wiper configured to remove solidified ink droplets around the first print head nozzle; and
a processor operatively connected to the inkjet print head and the capping unit, and configured to jet the cleaning liquid to the wiper through the inkjet print head.

2. The inkjet printing apparatus of claim 1, wherein the processor is further configured to:
in response to the inkjet print head and the capping unit being coupled to each other, move the capping unit such that the capping unit is detached from the inkjet print head;
in response to the capping unit being detached from the inkjet print head, move the inkjet print head such that the second print head nozzle is arranged at a position corresponding to a position of the wiper; and
jet the cleaning liquid to the wiper through the second print head nozzle.

3. The inkjet printing apparatus of claim 2, wherein the processor is further configured to, after jetting the cleaning liquid to the wiper through the second print head nozzle, move the capping unit in a direction toward the inkjet print head such that the capping unit and the inkjet print head are coupled again to each other.

4. The inkjet printing apparatus of claim 2, wherein the processor is further configured to adjust an amount of the cleaning liquid jetted through the second print head nozzle.

5. The inkjet printing apparatus of claim 4, wherein the inkjet print head further comprises:
a first piezoelectric element configured to discharge the ink droplets outside the inkjet print head through the first print head nozzle;
a second piezoelectric element configured to discharge the cleaning liquid outside the inkjet print head through the second print head nozzle; and
a sensor configured to detect a temperature of the cleaning liquid.

6. The inkjet printing apparatus of claim 5, wherein the processor is further configured to adjust an electrical signal applied to the second piezoelectric element based on the temperature of the cleaning liquid detected through the sensor, such that a constant amount of the cleaning liquid is capable of being jetted to the wiper.

7. The inkjet printing apparatus of claim 6, further comprising a memory, in which pieces of data regarding correlations between temperatures of the cleaning liquid and viscosities of the cleaning liquid are stored,
wherein the processor is further configured to adjust the electrical signal applied to the second piezoelectric element, based on the pieces of data regarding the correlations between the temperatures of the cleaning liquid and the viscosities of the cleaning liquid, the pieces of data being stored in the memory.

8. The inkjet printing apparatus of claim 1, further comprising:
a fixing wall arranged adjacent to the wiper; and
a roller configured to push the wiper in a direction toward the fixing wall.

9. The inkjet printing apparatus of claim 8, wherein the processor is further configured to have the wiper adhere to the fixing wall through the roller and then jet the cleaning liquid to the wiper through the inkjet print head.

10. The inkjet printing apparatus of claim 9, wherein the processor is further configured to additionally jet the cleaning liquid to the fixing wall and the roller by moving the inkjet print head.

11. The inkjet printing apparatus of claim 10, further comprising a scraper arranged to rotate with respect to the fixing wall and configured to remove the cleaning liquid remaining on the fixing wall.
